(19) United States
(12) Patent Application Publication
(10) Pub. No.: US 2006/0261605 A1
(43) Pub. Date: Nov. 23, 2006

(54) Device having magnetically rotary cover mechanism

(75) Inventors: Hung-Chung Ku, Taipei (TW); Chih-Kai Hu, Taipei (TW); Pin-An Hsieh, Taipei (TW)

Correspondence Address: BIRCH STEWART KOLASCH & BIRCH, PO BOX 747, FALLS CHURCH, VA, 22040-0747, US

(73) Assignee: ASUSTeK COMPUTER INC.

(21) Appl. No.: 11/433,460

(22) Filed: May 15, 2006

(30) Foreign Application Priority Data
May 17, 2005 (TW) 94115975

(51) Int. Cl. H02K 35/00; E05C 19/16

(52) U.S. Cl. 292/251.5; 310/15

(57) ABSTRACT

A device having a magnetically rotary cover mechanism is disclosed. Coupled magnets are pivotally mounted on one side of a cover cap of the device, and an attractive or repulsive force between the coupled magnets controls the cover cap to close an opening. The present invention uses the coupled magnets to replace the conventional elastic members for controlling the cover cap to close the opening, thereby simplifying and saving the process and time for assembling the device.

### RELATED APPLICATIONS

The present application is based on, and claims priority from, Taiwan Application Serial Number 94115975, filed May 17, 2005, the disclosure of which is hereby incorporated by reference herein in its entirety.

### BACKGROUND

1. Field of Invention

The present invention relates to a device, and more particularly, to the device having a magnetically rotary cover mechanism.

2. Description of Related Art

For effectively providing data and data storage required by users, many peripheral devices, such as a floppy disk drive, a hard disk drive, a CD-ROM drive, a CD-RW drive, a card reader and a DVD drive, etc., are installed on a computer system for providing data-accessing service. Roughly speaking, most of the conventional devices use a rotary cover to control the accessing of the electronic elements therein.

Referring to FIG. 1, FIG. 1 is an explosive view showing a conventional device having a rotary cover. The device 10 having the rotary cover includes a housing 11, a cover cap 13, rotation shafts 16 and an elastic member 19. The housing 11 is used for accommodating an electronic element (not shown), and an opening 15 is disposed on one side of the housing 11. The cover cap 13 is pivotally connected to the sidewalls of the opening 15, wherein the rotation shafts 16 are disposed respectively on one side 12a and the other side 12b of the cover cap 13, and holes 18 are disposed respective on one sidewall 14a and the other sidewall 14b of the opening 15, wherein the holes 18 are opposite to the rotation shafts 16. The elastic member 19 (such as a spring or an elastic slice) is used to connect the cover cap 13 with the other sidewall 14b of the opening 15.

The conventional device having the rotary cover uses the elastic force of the elastic member to control the cover cap to close or expose the opening. Referring to FIG. 2A, FIG. 2A is a cross-sectional diagram showing the procedure for moving the cover cap to expose the opening in the conventional device having the rotary cover. When an external force is exerted on the cover cap 13 along a direction 20, for example, when a storage medium in the housing 11 is moved out, the external force can rotate the cover cap 13 to a predetermined angle so as to expose the opening 15, such as shown in FIG. 2A, wherein the elastic member (not shown) is in a stretch state at this point.

Referring to FIG. 2B, FIG. 2B is a cross-sectional diagram showing the procedure for moving the cover cap to close the opening in the conventional device having the rotary cover. When another external force is exerted on the cover cap 13 along a direction 30, for example, when a storage medium is moved into the housing 11, the elastic recovery force of the elastic member (not shown) can rotate the cover cap 13 towards the opening 15 so as to close the opening 15, such as shown in FIG. 2B, In other words, the cover cap 13 closes the opening 15 via the elastic recovery force of the elastic member (not shown).

However, after the conventional device having the rotary cover has been used for quite a period of time, the elastic member therein shows elastic fatigue, thus resulting in poor tightness between the cover cap and the opening. Further, the process for assembling the conventional device having the rotary cover is complicated and time-consuming.

Hence, there is a need to provide a device having a rotary cover mechanism for overcoming the disadvantages of the conventional device.

### SUMMARY

One aspect of the present invention is to provide a device having a magnetically rotary cover mechanism, wherein a cover cap is pivotally mounted on the top of an opening of the device by using coupled magnets, thereby controlling the cover cap to close the opening via an attractive or repulsive force between the coupled magnets.

In accordance with the aforementioned aspect, a device having a magnetically rotary cover mechanism is provided, and comprises a housing having an opening, a cover cap, a first magnet and a second magnet, wherein a first engaging part is substantially adjacent to the opening, and the first magnet is mounted on the first engaging part. The cover cap is pivotally connected to the first engaging part via a second engaging part, wherein a second magnet is mounted on the second engaging part. When the cover cap covers the opening, the first magnet and the second magnet are reacted to each other via an attractive force.

In accordance with a preferred embodiment, the first magnet has a first north pole and a first south pole, and the second magnet has a second north pole and a second south pole.

In accordance with the preferred embodiment, when the cover cap covers the opening, the first north pole is substantially opposite to the second south pole.

In accordance with the preferred embodiment, when the cover cap is rotated to a predetermined angle, the first north pole is substantially opposite to the second north pole.

In accordance with the preferred embodiment, the first magnet is a ring magnet, and the first magnet surrounds the second magnet.

In accordance with the preferred embodiment, the second magnet is a solid inner circular magnet.

In accordance with the preferred embodiment, the second engaging part can be, for example, formed protrusively on one side of the cover cap.

When the device having the magnetically rotary cover mechanism is applied, since the cover cap is pivotally mounted on the top of the opening of the device by using the coupled magnets, the cover cap is controlled to close or expose the opening via an attractive or repulsive force between the coupled magnets. The present invention uses the coupled magnets to replace the conventional elastic members for controlling the cover cap to close the opening, so that the process and time for assembling the device can be greatly simplified and saved.

It is to be understood that both the foregoing general description and the following detailed description are examples, and are intended to provide further explanation of the invention as claimed.

### BRIEF DESCRIPTION OF THE DRAWINGS

These and other features, aspects, and advantages of the present invention will become better understood with regard to the following description, appended claims, and accompanying drawings where:

FIG. 1 is an explosive view showing a conventional device having a rotary cover;

FIG. 2A is a cross-sectional diagram showing the procedure for moving the cover cap to expose the opening in the conventional device having the rotary cover;

FIG. 2B is a cross-sectional diagram showing the procedure for moving the cover cap to close the opening in the conventional device having the rotary cover.

FIG. 3 is an explosive view showing a device having a magnetically rotary cover mechanism according to a preferred embodiment of the present invention;

FIGS. 4A and 4B are cross-sectional diagrams showing the procedure for moving the cover cap to expose the opening in the device having the magnetically rotary cover mechanism according to the preferred embodiment of the present invention;

FIG. 4C is a cross-sectional diagram showing the procedure for moving the cover cap to close the opening in the device having the magnetically rotary cover mechanism according to the preferred embodiment of the present invention;

FIG. 5A is a 3-D diagram showing the procedure for moving the cover cap to expose the opening in the device having the magnetically rotary cover mechanism according to the preferred embodiment of the present invention; and

FIG. 5B is a 3-D diagram showing the procedure for moving the cover cap to close the opening in the device having the magnetically rotary cover mechanism according to the preferred embodiment of the present invention

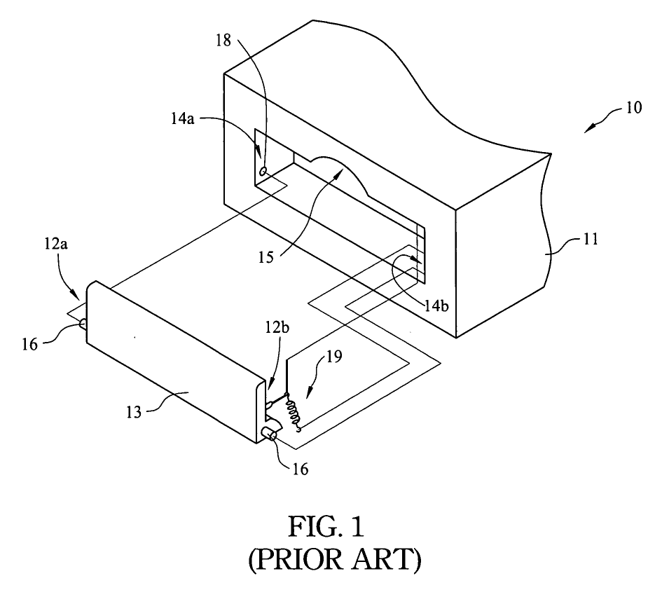

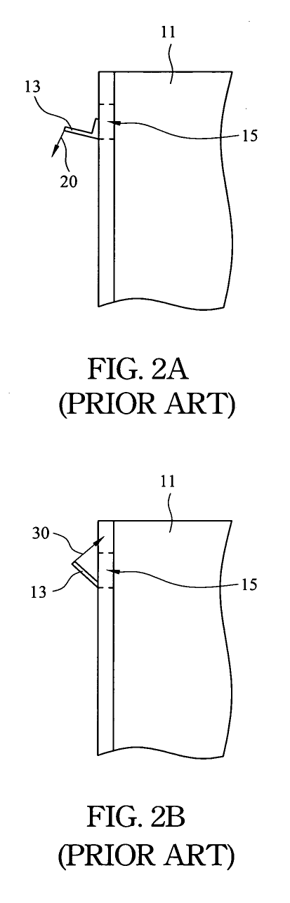

### DESCRIPTION OF THE PREFERRED EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

The present invention provides a device having a magnetically rotary cover mechanism, wherein a cover cap is pivotally mounted in the opening of the device by using coupled magnets, wherein an attractive or repulsive force between the coupled magnets is used to control the cover cap to close or expose an opening. Hereinafter, the detailed description of the present invention will be stated in accompany with the figures for explaining the device having the magnetically rotary cover mechanism in accordance with the present invention.

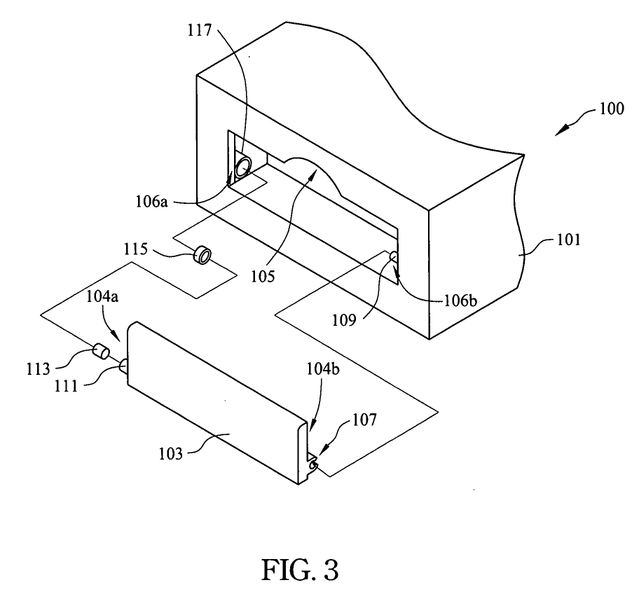

Referring to FIG. 3, FIG. 3 is an explosive view showing a device having a magnetically rotary cover mechanism according to a preferred embodiment of the present invention. The device 100 having the magnetically rotary cover mechanism comprises a housing 101, a cover cap 103, a first magnet 115 and a second magnet 113. The housing 101 is used for accommodating electronic elements (not shown), and one side of the housing 101 has an opening 105, wherein a first engaging part 117 is substantially adjacent to the opening 105, such as adjacent to a side 106a of the opening 105, and the first magnet 115 is mounted on the first engaging part 117. The cover cap 103 is pivotally connected to the first magnet 115 of the first engaging part 117 via a second engaging part 111, wherein the second engaging part 111 is formed protrusively on a side 104a of the cover cap 103, and a second magnet 113 is mounted inside the second engaging part 111.

In one exemplary embodiment, when the second magnet 113 is merely disposed on the side 104a of the cover cap 103, a pivot part 107 can be optionally disposed on the other side 104b of the cover cap 103, and a rotation shaft 109 can be disposed on the other side 106b of the opening 105, wherein the pivot part 107 is fastened on the rotation shaft 109. Alternatively, when the second magnet 113 is merely disposed on the side 104a of the cover cap 103, a rotation shaft (not shown) can be optionally disposed on the other side 104b of the cover cap 103, and a pivot part (not shown) can be disposed on the other side 106b of the opening 105, wherein the rotation shaft is also fastened on the pivot part. Optionally, the second magnets 113 can be disposed respectively on the side 104a and the other side 104b of the cover cap 103, and the first magnets 115 also can be disposed respectively on the first engaging parts 117 disposed on the side 106a and the other side 106b of the opening 105, and thus two second magnets 113 are opposite to those two first magnets 115 respectively.

It is worthy to be noted that the device of the present invention is featured in the cover cap 13 using two coupled magnets. For example, the first magnet 115 and the second magnet 113 that are coupled to each other are disposed on one side of the opening 105, whereby an attractive or repulsive force between the coupled first and second magnets 115 and 113 are used to control the cover cap 103 to expose or close the opening 105. In a preferred embodiment of the present invention, the first magnet 115 is a ring magnet, surrounds the second magnet 113. In the other preferred embodiment of the present invention, the second magnet is a solid inner circular magnet, and is disposed in the second engaging part 111; and the first magnet 115 is an outer ring magnet, and is disposed in the first engaging part 117 of the side 106a of the opening 105.

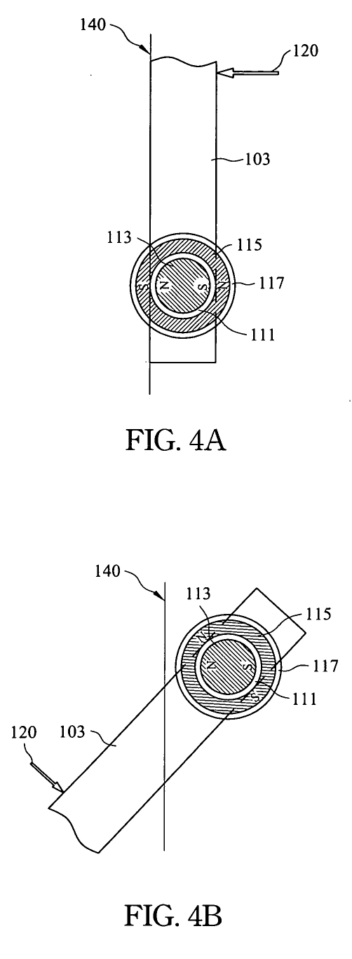

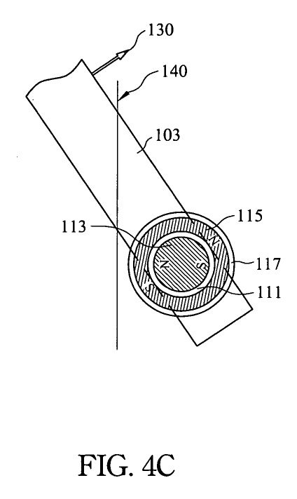

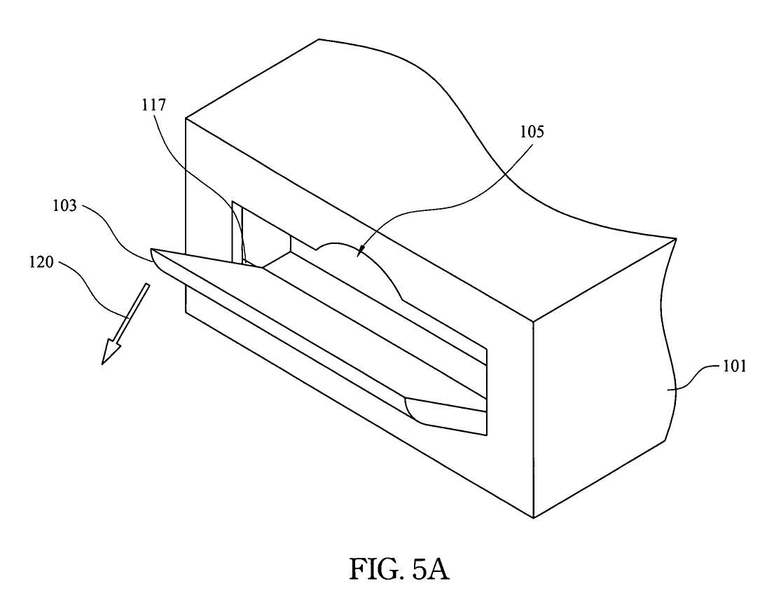

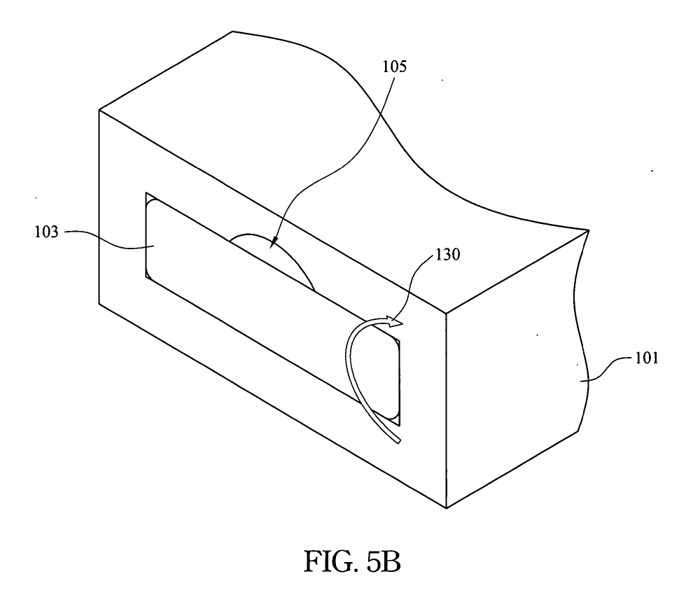

Concretely speaking, the present invention controls the cover cap 103 to expose or close the opening 105 via attraction or repulsion between the first magnet 115 and the second magnet 113. Referring to FIG. 4A to FIG. 4B together with FIG. 5A, FIGS. 4A and 4B are cross-sectional diagrams showing the procedure for moving the cover cap to expose the opening in the device having the magnetically rotary cover mechanism according to the preferred embodiment of the present invention; and FIG. 5A is a 3-D diagram showing the procedure for moving the cover cap to expose the opening in the device having the magnetically rotary cover mechanism according to the preferred embodiment of the present invention. In an exemplary embodiment of the present invention, the first magnet 115 has a first north pole N and a first south pole S in the longitudinal direction, and the second magnet 113 has a second north pole N′ and a second south pole S′ in the longitudinal direction, such as shown in FIG. 4A. When the cover cap 103 closes the opening 105, the cover cap 103 is parallel to the opening side 140. When a force is exerted on the cover cap 103 along a direction 120, for example, when a storage medium in the housing 101 is moved out, the force can make the cover cap 103 rotate to a predetermined angle so as to expose the opening 105, such as shown in FIG. 5A. At this point, the first magnet 115 and the second magnet 113 repel each other, such as shown in FIG. 4B. The predetermined angle indicated herein is the rotation angle of the cover cap 103 with respect to the opening 105. Generally speaking, when the predetermined angle is great than or equal to 90 degrees, the first north pole N is substantially opposite to the second north pole N′, so that the first magnet 115 repels the second magnet 113.

Referring to FIG. 4C together with FIG. 5B, FIG. 4C is a cross-sectional diagram showing the procedure for moving the cover cap to close the opening in the device having the magnetically rotary cover mechanism according to the preferred embodiment of the present invention; and FIG. 5B is a 3-D diagram showing the procedure for moving the cover cap to close the opening in the device having the magnetically rotary cover mechanism according to the preferred embodiment of the present invention. On the other hand, when the other force is exerted on the cover cap 103 along a direction 130, for example, when a storage medium is moved into the housing 101, the repulsive force between the first magnet 115 and the second magnet 113 can make the cover cap 103 rotate towards the opening surface 140 so as to close the opening 105, such as shown in FIG. 5B. At this point, the first north pole N is substantially opposite to the second south pole S′, i.e. the first magnet 115 attracts the second magnet 113, so that the cover cap 103 closes the opening 105.

Briefly speaking, the device of the present invention having the magnetically rotary cover mechanism uses the coupled magnets to control the cover cap for exposing or closing the opening, and thus the cover cap is preferably made of non-magnetic material, such as plastic material. This concept is well known to those who are skilled in the art, and thus is not described in detail herein. Moreover, the present invention replaces the conventional elastic members with the coupled magnets for controlling the cover cap to close the opening, so that the process and time for assembling the device can be greatly simplified and saved.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A device having a magnetically rotary cover mechanism, comprising:
a housing having an opening, wherein a first engaging part is substantially adjacent to the opening, and a first magnet is mounted on the first engaging part; and
a cover cap pivotally connected to the first engaging part via a second engaging part, wherein a second magnet is mounted on the second engaging part;
wherein, when the cover cap covers the opening, the first magnet and the second magnet are reacted to each other via an attractive force.

2. The device having the magnetically rotary cover mechanism as claimed in claim 1, wherein the first magnet has a first north pole and a first south pole, and the second magnet has a second north pole and a second south pole.

3. The device having the magnetically rotary cover mechanism as claimed in claim 2, wherein, when the cover cap covers the opening, the first north pole is substantially opposite to the second south pole.

4. The device having the magnetically rotary cover mechanism as claimed in claim 2, wherein, when the cover cap is rotated to a predetermined angle, the first north pole is substantially opposite to the second north pole.

5. The device having the magnetically rotary cover mechanism as claimed in claim 1, wherein the first magnet is a ring magnet, and the first magnet surrounds the second magnet.

6. The device having the magnetically rotary cover mechanism as claimed in claim 1, wherein the second magnet is a solid inner circular magnet.

7. The device having the magnetically rotary cover mechanism as claimed in claim 1, wherein the second engaging part is formed protrusively on one side of the cover cap.
